(19) United States
(12) Patent Application Publication
(10) Pub. No.: US 2005/0154920 A1
(43) Pub. Date: Jul. 14, 2005

(54) Method and apparatus for biometric template data management

(76) Inventors: Shawn Michael Tartaglia, Lake Worth, FL (US); Dore Scott Perler, Cooper City, FL (US)

Correspondence Address: ALLEN D. HERTZ, 12784 TULIPWOOD CIRCLE, BOCA RATON, FL, 33428, US

(21) Appl. No.: 11/028,372

(22) Filed: Jan. 3, 2005

Related U.S. Application Data
(60) Provisional application No. 60/533,665, filed on Dec. 31, 2003.

(51) Int. Cl. H04L 9/32

(52) U.S. Cl. 713/201

(57) ABSTRACT

The invention is for a method and apparatus of biometric data collection, distribution and management. The method allows for the collection of biometric data and the management and distribution of that data though at least one but preferably a network of biometric reading devices. The biometric reading devices can be used in conjunction with currently known applications or custom developed applications that can utilize data collected and managed throughout a network of remote biometric devices. These remote biometric reading devices can be used to perform time and attendance functions, access control functions, work release prisoner monitoring or any end use where information is managed and gathered to identify a person scheduled to be at a particular remote biometric device at a particular time. The system utilizes a Biometric Data Server (BDS) to manage and maintain Biometric templates, placing a removing the Biometric templates on remote biometric reading devices in conjunction with a predetermined directive. This process increases the efficiency and speed of the remote biometric device.

### RELATED PATENT APPLICATIONS

This application claims priority to Provisional Patent Application 60/533,665 filed on Dec. 31, 2003. Provisional Application 60/533,665 is incorporated herein by reference. Dec. 31^{st}, 2004 is a National Holiday in the District of Columbia, therefore applications are co-pending through the next business day (Jan. 3^{rd}, 2005).

### FIELD OF THE INVENTION

The invention relates generally to a method and apparatus for data management for biometric templates within a system. The apparatus comprises a registration unit, a check-in unit, a biometric data server and respective software. The method comprises the steps of storing registered biometric template data collected from the registration unit in a biometric data server and transferring the data to and from the desired check-in unit visa vie software commands.

### BACKGROUND OF THE INVENTION

There currently exist many systems for collection and storage of biometric data. To date many of the systems have collected the biometric data and stored that data in a single unit biometric scanning device. However, this type of system is specifically limited in the amount of data that can be stored by the single unit as defined by the storage capacity of the single unit. In addition, the data is typically contained in the single unit and cannot be shared among other units.

Data is collected and stored in the single unit during a registration process. The registration process happens at the single unit. The registration process will collect and create registered data, or biometrics templates, that can be used to look up and verify the person using the biometric device. The verification is done in the single unit by the application of an algorithm to a biometric being scanned to create a data string. The data string is then compared against the database of stored registered biometric templates.

The single unit configuration suffers many limitations that will be discussed herein. First, the user has to register at the individual biometric scanning device. This is problematic where there are many biometric scanning devices that are going to be deployed throughout a single infrastructure. Second, as the number of users increase the computing power and storage capacity of the biometric scanning device must also be increased, subsequently increasing the cost of the unit. Moreover, as the number of users increases the performance of the biometric scanning device can be compromised. The number of stored biometric templates increases the chances of matching the scanning biometric data string to an incorrect registered data string increases. This problem is typically known as a false accept. To date the problem has been addressed by increasing the amount of data points that comprise the scan data string and the stored biometric data template. This decreases the chance of a false accept but it does not eliminate false accepts. Moreover, an increase in data points increases processing time and data storage size. An increase in processing time makes use of the check-in unit less favorable and an increase in data storage increases the cost of the data storage unit. The increased data string also increases the chances that a user otherwise registered will not be recognized as all of the data points do not match a stored data string, which is typically known in the industry as a false reject.

To date existing systems work best when there are a limited number of biometric templates, with a limited number of data points used in a biometric registration and identification system. However, this limits applications of biometric registration and check-in systems to applications involving a limited number of people. When the application calls for a large number of people, for example one thousand employees, present systems fail to operate at optimal performance or at all. In addition, where there are multiple check-in sites for the large number of employees, present systems are limited in deployment because there has to be a registration at each unit.

Past efforts have attempted to solve this problem by providing a server based identification of biometric templates whereby the biometric scanning device would send captured images to an authentication server. At the authentication server the data processing and verification would take place and the result would be transferred back to the biometric imaging device. However, this configuration is not optimal in that it requires the passing of an image or multiple images to and from the server, which requires significant time to transfer.

An example of how this system is limited must incorporate the specifics of how look up and verification works. Typically, a registered user places a finger on a biometric scanner and the process of identification begins. The process is polling images from the user, which causes several images to be captured and translated for the verification software. Often the finger placement on the scanner will be different then that which was registered and causes the user to move her finger slightly to obtain an appropriate acceptance of the biometric. Where the system is sending images across a network to a server and all of the computing is taking place at the server this leads to large processing time thus negating the speed and ease of use of the system. Thus the polling of images and shifting of the finger requires communication between the scanning device and the look up and verification software residing on the server.

Moreover, as the number of users increases, and the amount of individuals scanning simultaneously increases the burden on the server based application verification becomes very cumbersome. In order to have a server based look up and verification of a large number of users that may access the server simultaneously, the server has to be configured with a great deal of processing and storage capacity. Thus the cost and performance of the server-based application is greatly affected by the number and frequency of use. One could parallel this effect to the number of hits on an internet based server, where too many hits at a single point in time could slow or cease the function of the server.

Often the process between the biometric scanning device in the data string that is ultimately used to verify a user involves a series of image enhancing software subroutines. Where image enhancing software subroutines are running on a server while an image is being collected at a biometric scanning device the amount of data transfer that must take place between the scanning device and the server becomes a limiting factor. Therefore, there is a great advantage in imaging and look up and verification that is done locally as it decreases the amount of time needed to complete the process.

The key problem is to overcome the limitations of single unit biometric systems while maintaining the performance advantages of single unit biometric systems.

### SUMMARY OF THE PRESENT INVENTION

The present invention relates to a system that utilizes a central server for data storage and single units connected thereto for local processing of the central stored information. The system further manages the data to be distributed throughout the system of single units whereby centrally stored information is sent to and retrieved from the single units. Therefore, through proper management of the centrally stored information no single unit is ever overburdened by the storage of too much information. As information is required at any single unit it is sent to the unit for a predetermined amount of time and removed from the unit when it is no longer required. Thus local verification of users is accomplished without complete storage of the entire data set at the single unit. Moreover, the central server is not over burdened by the requirement of imaging, look up and verification that is done by the local unit. Hence the server storage and computing requirements are lessened and the data transfer time between the central server and the individual units are reduced.

Therefore, the present invention addresses the great need to develop a system for biometric identification that can be deployed; a system comprising a number of devices and capable of being used by a large population while not requiring registration or storage of data in the individual devices. The system must also be able to look up and verify individuals in a timely manner. The present invention addresses all of the limitation and needs of current biometric registration and check-in systems and their uses thereof.

The present invention relates to a system that can be used by a large number of people at multiple locations improving the performance of the registration and check-in biometric systems. The system comprises biometric scanning units, biometric registration stations, biometric administration stations and a biometric distribution server.

The present invention further discloses a method of moving the data strings to and from the registration to the biometric distribution server and to the biometric scanning units visa vie the biometric administration stations.

The prior art references fail to disclose a system that utilizes a combination of these elements in a manner disclosed herein to facilitate deployment of a biometric authentication system.

### ASPECTS OF THE PRESENT INVENTION

According to the present invention, a system is disclosed for a biometric authentication system that comprises at least one biometric scanning device, a registration point, an administration station and a biometric distribution server.

A first aspect of the present invention is a biometric authentication system that operates with optimal speed and reliability where biometric authentication templates are stored in a central server.

A second aspect of the present invention is a less expensive biometric system for multiple locations having numerous users.

A third aspect of the present invention is a system that is easy to use in the field.

A fourth aspect of the present invention is to provide a biometric system that eliminates multiple points of failure.

A fifth aspect of the present invention is a system that can be centrally administrated visa vie an administration station.

A sixth aspect of the present invention is a biometric authentication system that distributes needed biometric information to specific single biometric scanning devices across a network of devices.

A seventh aspect of the present invention is to provide a biometric scanning system that can locally perform look up and authentication and report all transactions involving look up and authentication back to a central server.

An eighth aspect of the present invention of the present invention is to provide a software programming platform that can turn the transaction data reported back to the central server from the single units into useful business information such as time and attendance reporting or access control information.

A ninth aspect of the present invention is to provide transaction history reports that can be user defined regarding the transaction collected by single units and reported back to the central server.

A tenth aspect of the present invention of the present invention is to provide a software platform that enables the communication between the central server in the single units whereby biometric templates can be sent from the central server to the single units when required and removed from the single units when not required by the single unit.

Additional aspects of the present invention will become apparent from the disclosure herein and are claimed as aspects of the invention as if described herein.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 shows a system diagram of the biometric distribution server system.

FIG. 2 shows a general data flow diagram for use of the system.

FIGS. 3 and 4 provide additional detail respective to FIG. 2.

FIG. 5 shows a system diagram for the data flowing to the Biometric Data Server.

FIGS. 6 and 7 show a system diagram for the data flowing from the Biometric Data Server.

Like reference numerals refer to like parts throughout the several views of the drawings.

The figures illustrated are representative of the present invention and the scope of the present invention should comprise the concept and not be limited to the exact teachings within.

### DETAILED DESCRIPTION OF THE INVENTION

Shown throughout the figures, the present invention is directed towards a Biometric Authentication System 10. The system includes at least one of a an administration workstation 15, a Registration Station 20, a Biometric Sensor 30, a Biometric Distribution Server (BDS) 40, Template Distribution Manager Software 50 and a Collection Device 60 having a Collection Device Biometric Sensor 70. For purposes of this detailed description, and not in anyway as a limiting factor to this disclosure, employee will be used interchangeably with any system user.

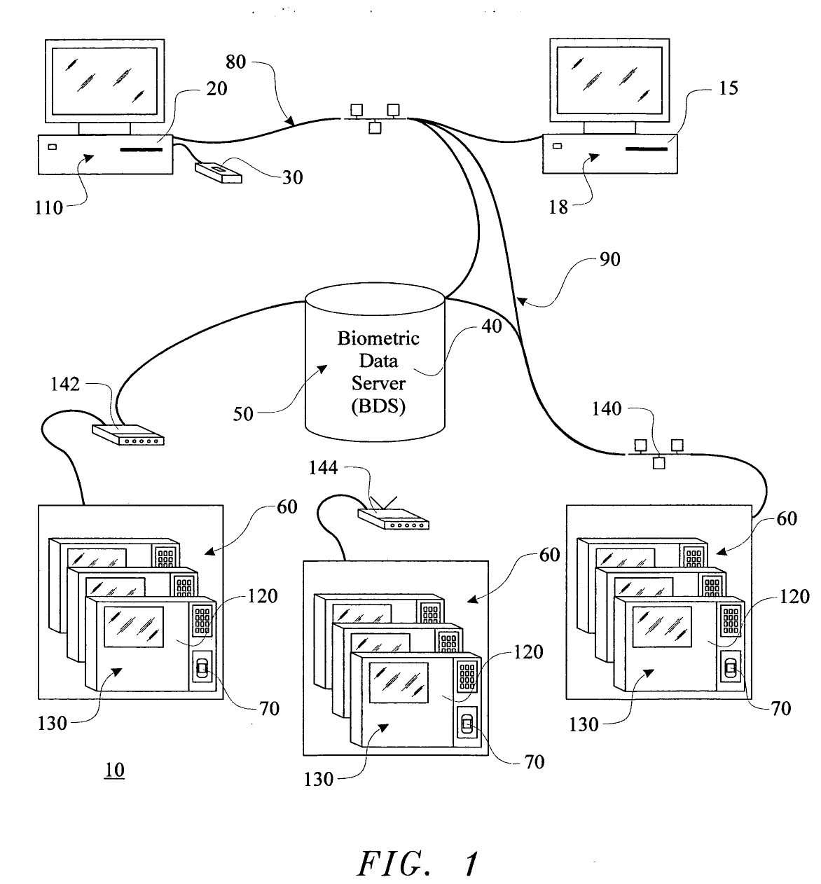

Referring now primarily to FIGS. 1, 2, 3, and 4, the first and preferred embodiment of the invention, the Registration Station 20, which is typically a standard desktop personal computer comprising Custom Registration Software 110, has Biometric Sensor 30 electronically attached thereto. Registration Station 20 is connected to the Biometric Distribution Server 40, which is typically server based hardware and database software, through typical computer network communications. Template Distribution Manager Software 50 resides on the Biometric Distribution Server 40. Collection Device 60, typically comprising custom designed hardware Bioclock® 120 and custom Lookup and Match Software 130, is connected to Biometric Distribution Server 40 through typical computer network connections.

The system can be managed through the administration workstation 15. Administration software resides on the administration workstation 15. It can be recognized that the administration workstation 15 and the Registration Station 20 can be the same unit.

An end user is registered at Registration Station 20 using Registration Software 110. The end user places a finger on Biometric Sensor 30 and Registration Software 110 captures a fingerprint image and converts the image into a numeric data string that is packaged with other data to create Registration Data 80. Registration Data 80 is transmitted and stored on Biometric Distribution Server 40. Registration Data 80 is comprised of the end user's numeric data string known as a biometric template, and where appropriate other identifies such as name, identification number and schedule for appearance and presentation of registered print at a remote biometric device. Registration Data 80 is managed by Template Distribution Manager Software 50 so that Registration Data 80 is sent to Collection Device 60 at predetermined intervals based the end user's typical schedule.

Collection Device 60 receives the end user's Registration Data 80 at predetermined times and stores it in internal memory until it is purged by a command sent from Template Distribution Manager Software 50, a time-out consideration, a preprogrammed time window, and the like. While the end user's data resides on Collection Device 60 the end user may utilize Collection Device 60 to be biometrically recognized by Collection Device Fingerprint Sensor 70. The process of recognition involves imaging the end user's fingerprint using Fingerprint Sensor 70, converting the image into a numeric data string and comparing/matching the numeric data string with Registration Data's 80 stored numeric data string. Recognition of the end user allows Collection Device 60 to be utilized to perform functions such as access control, time and attendance monitoring, prisoner work release authorization, patient arrival, or other predetermined function.

The functions performed by Collection Device 60 are stored in the memory of Collection Device 60 and Reporting Data 90 is transferred back to Biometric Distribution Server 40 at predetermined intervals. Biometric Distribution Server 40 uses Reporting Data 90 collected from Collection Device 60 in any one of many ways as defined by Biometric Authentication System 10 deplorer. For example, Reporting Data 90 can be used to determine payroll for the employees that have utilized Collection Device 60 for time and attendance. Likewise, Reporting Data 90 can be used to create an access log when utilized by an employee for access control.

The significance of managing Registration Data 80 is that large data packets containing biometric templates can be stored in Biometric Distribution Server 40 and temporarily placed at Collection Device 60. Collection Device 60 only needs storage capacity large enough to store routed Registration Data 80, which is subsequently removed from Collection Device 60 at predetermined times by a command sent to Collection Device 60 by Template Distribution Manager Software 50. Registration Data 80, can alternatively be removed from Collection Device 60 at by alternate controlling functions, such as after a person leaves an area, after a different person activates said Collection Device 60, and the like.

In a typical system there will be a plurality of Collection Devices 60 in communication with Biometric Distribution Server 40. Limiting the memory requirements of Collection Devices 60 significantly reduces the costs the overall system. Collection Device 60 is burdened with the storage and processing requirements of running Lookup and Match Software 130. Requiring Collection Device 60 to store a large set of Registration Data 80 is impractical and redundant. In addition, multiple Collection Devices 60 would have to be synchronized through a deployment with all of a company's Registration Data 80 each time a change was made to Registration Data 80 dataset. However, the present invention allows the control of data at a single or bank of Biometric Distribution Server(s) 40. Thus any changes in Registration Data 80 is done on a single computing device (or grouped server bank), a Biometric Distribution Server 40. For example if an employee is terminated the change is made to Registration Data 80 on Biometric Distribution Server 40 and that employee may not gain access through any of the plurality of Collection Devices 60 even though they are remotely located. Moreover, the system can be configured whereby no end user can use their Registration Data 80 to access a remote device that they are not scheduled to be at by Distribution Manager Software 50. Alternately, the system can be configured whereby the Collection Device 60 can request the Registration Data 80 should the collection device 60 become unsuccessful in finding a match. One such example would be an employee desiring access via recognition by a Collection Device 60 after hours. The Registration Data 80 can include allowance for employees access after standard hours. Alternately, the Registration Data 80 can deny allowance for employees access after standard hours.

Moreover, limiting the amount of Registration Data 80 stored at Collection Devices 60 significantly increases the performance of Collection Devices 60. By managing the database residing on Collection Device 60 visa-vie Template Distribution Manager Software 50, Lookup and Matching Software 130 only compares resultant locally processed values against Registration Data's 80 numeric values that have been imported to Collection Device 60. It would be impractical to lookup and match results of Lookup and Match Software 130 with the entire Registration Data 80 contained on Biometric Distribution Server 40. This comforts the user, whereby should the Collection Device 60 comparison process take extended time-spans, the user would question the biometric registration process and begin trying to resolve questionable reading processes by adjusting the positioning of the biometric registration. This would only confuse the process.

A typical deployment would have Registration Data 80 for thousands of employees. The employees would be working throughout a company having several distinct locations and specific employees assigned to the locations at specific times. The assignment of employees to specific location at specific times comprises Employee Schedule 80a. Employee Schedule 80a is a subset of Registration Data 80 that interfaces with Template Distribution Manager Software 50 to instruct Biometric Distribution Server 40 to send Registration Data 80 to specific Collection Devices 60. For example, one hundred employees may be working at location X between the hours of 8:00 A.M. and 5:00 P.M. Template Distribution Manager Software 50 would instruct Biometric Distribution Server 40 to send the respective one hundred Employee's Registration Data 80 to respective Collection Device(s) 60 located at location(s) X at 7:30 AM. In addition, a command is sent to Collection Device 60 to remove all Registration Data 80 at 5:30 P.M. The Employee's Registration Data 80 can be sent to a single or plurality of Collection Device(s) 60.

Collection Device 60 is also sending Report Data 90 to Biometric Distribution Server 40 during the time that those one hundred employees are utilizing Collection Device 60. In the preferred embodiment, Report Data 90 is a small data packet that can be stored on Collection Device 60 for a predetermined amount of time to act as a data backup for Reporting Data 90 sent to Biometric Distribution Server 40.

Another function of Template Distribution Manager Software 50 would be the removal of an employee from Biometric Distribution Server 40. Upon removal of an employee from Biometric Distribution Server 40 the employee could no longer use Collection Device 60 as means for access or clocking in and out of work.

Finally, sending Reporting Data 90 back to said Biometric Distribution Server 40 allows for system wide monitoring and reporting of Collection Device(s) 60.

Interfacing means between said components can include Ethernet 140, modem 142, wireless 144, USB (not illustrated), RS232 (not illustrated), and the like. It should be noted, that the specific method of communications described of utilizing the present invention are only several examples and a wide variety of other communications means for optimal conditions for each application are contemplated.

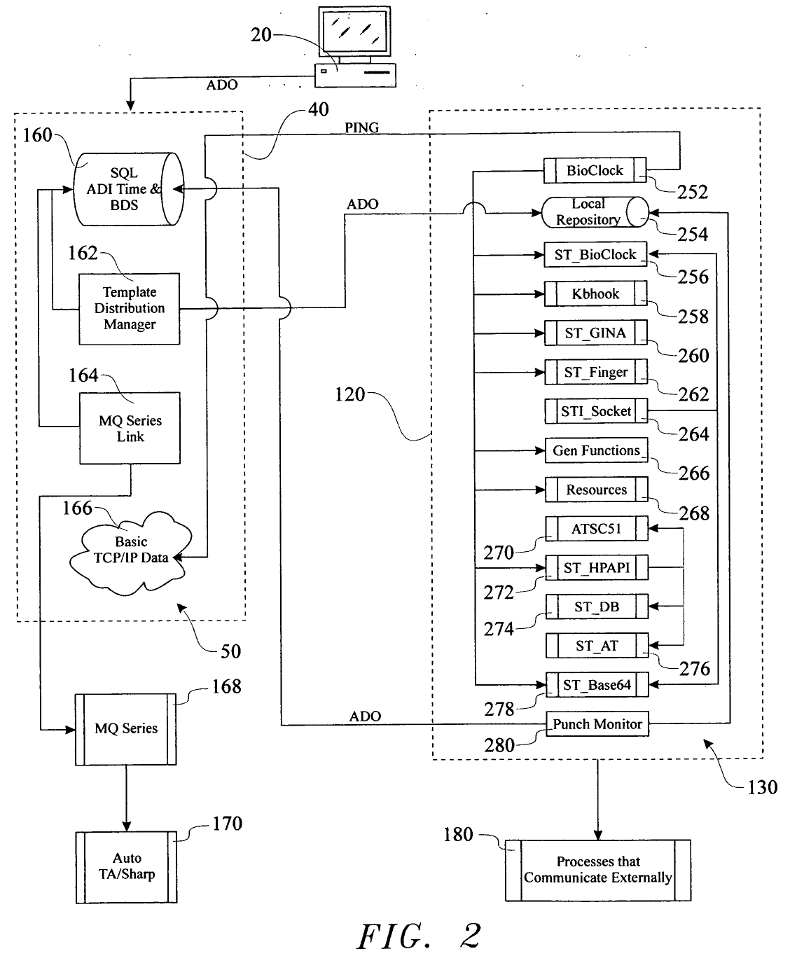

FIG. 2 illustrates a data flow diagram representing the method and details of the Biometric Template Management process in conjunction with the present invention.

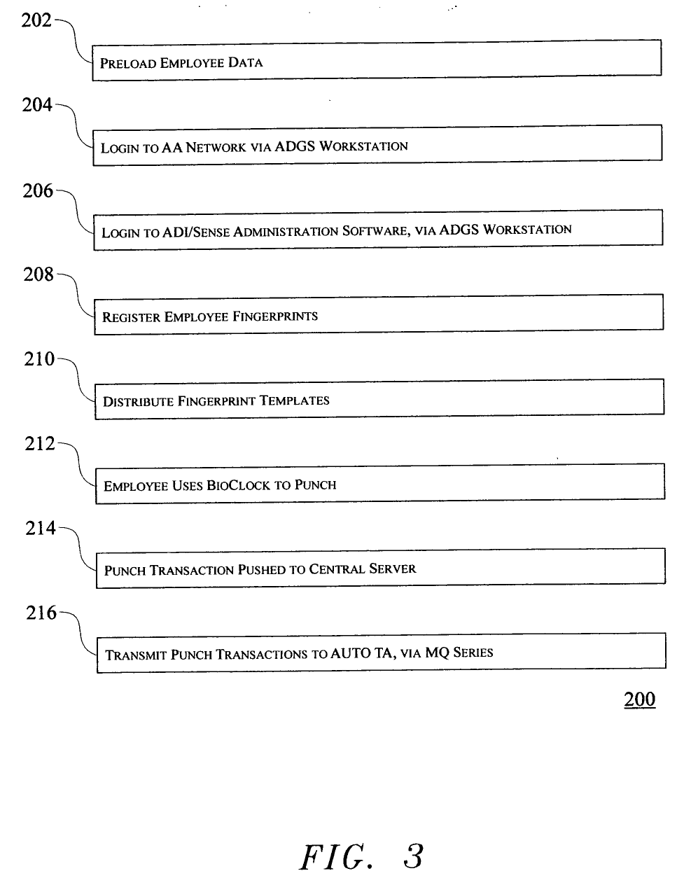

FIG. 3 provides a flow diagram overview respective to FIG. 2.

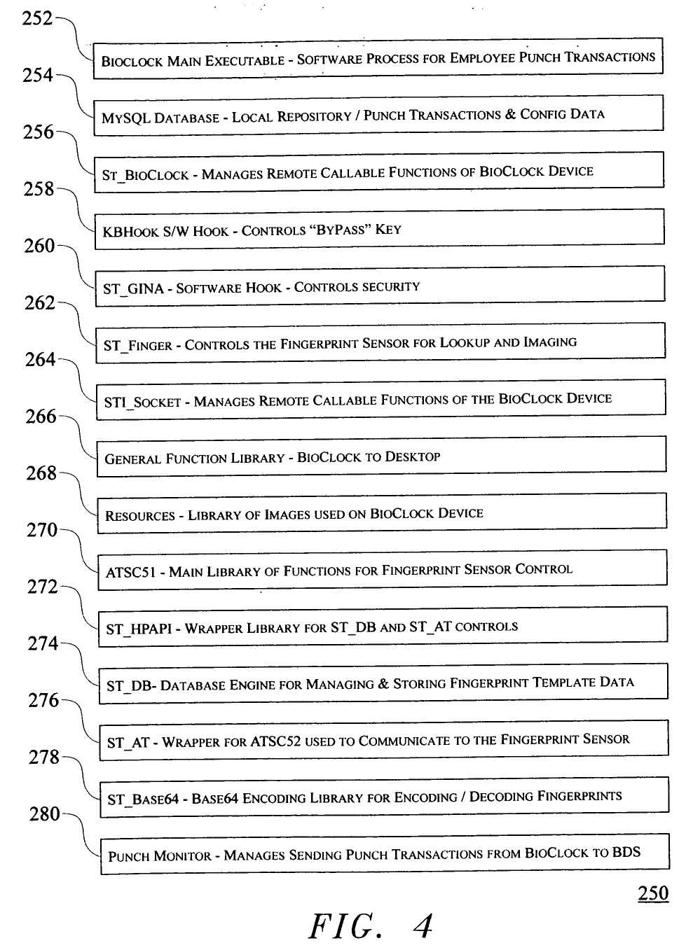

FIG. 4 provides additional details respective to the representative software flow of custom Lookup and Match Software 130 illustrated in FIG. 2.

The Biometric Template Data Management process flow 200 initializes with a first data management step 202 of preloading employee data. The data resides on the Biometric Distribution Server (BDS) 40. A second data management step 204 provides the ability for a party/to login to the AA Network via the Registration Station 20 as well as allowing the Registration Station 20 to login to the Central Biometric Distribution Server (BDS) 40. A third data management step 206 provides the ability to Login to the ADI/General Administrative Software via the Registration Station 20. A fourth data management step 208 provides the ability for the employee/party to register fingerprints using the Registration Station 20. The fingerprint templates are transferred to and stored on the Biometric Distribution Server (BDS) 40. Additional template information can be added, including, but not limited to, directives for the system. Such directives can include which Bioclock®(s) 120 are to receive the fingerprint templates, at what time the registered party can utilize the Bioclock®(s) 120, and the like. A fifth data management step 210 distributes the fingerprint templates from the Central Biometric Distribution Server (BDS) 40 to the respective Bioclock®(s) 120 based upon the directives provided. A Template Distribution Manager 162 (the primary engine of the Template Distribution Manager Software 50) provides the controls for the management and distribution of the fingerprint templates. Data is communicated between the Template Distribution Manager Software 50 and a local repository 254, a component of the Bioclock® 120. A sixth data management step 212 provides for the employee/party to use the Bioclock® 120 to punch in. (The steps for the Bioclock® 120 software comprising the Lookup and Match Software 130 are detailed further within the specification.) In a seventh data management step 214, the Bioclock® 120 interfaces with the Biometric Distribution Server (BDS) 40 for recordation of the event. This is accomplished whereby a punch monitor 280 (a software subroutine within the Lookup and Match Software 130) provides the data that is communicated to an SQL ADI Time and Biometric database server. In an eighth data management step 216, the Biometric Distribution Server (BDS) 40 transmits the punch transaction to an MQ Series 168 and an Auto TA/sharp 170 via a MQ Series link 164. Alternate means for communicating and tracking employee punch (or other) registrations can be utilized.

Communications are provided by any of various known means. Depicted for Biometric Distribution Server (BDS) 40 communications is a commonly known TCP/IP data communication protocol 166. Bioclock® 120 communications are accomplished via any of know means of communicating externally 180. The present invention should not be limited to the means of communicating between devices as the application would be selectable by the system configurator.

FIG. 4 provides an overview of the function of the Bioclock® 120 (Bioclock® software 250) including details of the Lookup and Match Software 130. A first Bioclock® software component 252 comprising a Main Executable subroutine. The reduction to practice utilizes Visual Basic software that provides the overall management of the software subroutine processes. A second Bioclock® software component 254 comprising a database and respective database management software. The reduction to practice utilizes a MySQL database for recording and managing the information. A third Bioclock® software component 256 is referenced as St_BioClock which manages remote callable functions of the BioClock® 120. Examples of such callable functions include Shutdown, Restart, Lock, Unlock, and Refresh. The reduction to practice utilizes Visual Basic software for the St_BioClock subroutine. A fourth Bioclock® software component 258 is referenced as KBHook which is a software hook that controls “Bypass” keys of the operating system. One feature provided by this software component is that KBHook secures the Bioclock® device 120 from intruders with keyboard access. Examples of hooks include Ctrl+Alt+Del and Alt+Tab. The reduction to practice utilizes Visual Basic software for the KBHook subroutine. A fifth Bioclock® software component 260 is referenced as ST_GINA which is a software hook that aids the fourth Bioclock® software component 258 KBHook for controlling security of the Bioclock® device 120. The reduction to practice utilizes Visual Basic software for the ST_GINA subroutine. A sixth Bioclock® software component 262 is referenced as ST_Finger which is a software routine which controls the fingerprint sensor for Lookup and Imaging. The reduction to practice utilizes Visual Basic software for the ST_Finger subroutine. A seventh Bioclock® software component 264 is referenced as STI_Socket which is a software routine which manages remote callable functions of the Bioclock® device 120. Examples of callable functions managed by STI_Socket include Set and get Time and date, checking the status of lock or unlock of the system, and the like. The reduction to practice utilizes Visual Basic software for the STI_Socket subroutine. An eighth Bioclock® software component 266 is referenced as General Function Library which comprise a series of generic system functions, including, but not limited to, controlling remote functions such as locking desktop, read/write to configuration files, turn off system tray, and the like. The reduction to practice utilizes Visual Basic software for the General Function Library components. A ninth Bioclock® software component 268 is referenced as Resources which comprise a library of images used on the Bioclock® device 120. Examples of the library of images include Bitmaps, Icons, Sounds, and the like. A tenth Bioclock® software component 270 is referenced as ATSC51 which comprise the main library of functions to control the fingerprint sensor. The reduction to practice utilizes Visual Basic software for the ATSC51 components. An eleventh Bioclock® software component 272 is referenced as ST_HPAPI which comprise the Wrapper library of functions used in conjunction with ST_DB and ST_AT (both detailed below); all used by the Bioclock® device 120 to control the fingerprint sensor. The reduction to practice utilizes Visual Basic software for the ST_HPAPI components. A twelfth Bioclock® software component 274 is referenced as ST_DB which comprise a proprietary database engine for managing and storing fingerprint template data. The reduction to practice utilizes Visual Basic software for the ST_DB engine. It should be understood that the proprietary database engine need not be disclosed as reading/creating/writing the fingerprint template data in various forms is know. This particular reduction to practice utilizes a proprietary database engine. Other's can use different engines to obtain the same objective and reduce the present invention to practice. A thirteenth Bioclock® software component 276 is referenced as ST_AT comprising a wrapper for ATSC51 (the tenth Bioclock® software component 270) used to communicate to the fingerprint sensor. Also processes the templates via an embedded algorithm. The reduction to practice utilizes Visual Basic software for the ST_AT engine. A fourteenth Bioclock® software component 278 is referenced as ST_Base64 which comprise a proprietary base64 encoding library used to encode and decode the fingerprint templates and other data for security and management requirements. The reduction to practice utilizes Visual Basic software for the ST_Base64 engine. It should be understood that the base64 encoding library need not be disclosed as other encoding libraries can be used in conjunction with fingerprint template data. This particular reduction to practice utilizes a proprietary base64 encoding library. Other's can use different encoding libraries to obtain the same objective and reduce the present invention to practice.

A fifteenth Bioclock® software component 280 is referenced as Punch Monitor which manages sending punch transactions between the Bioclock® device 120 and the Biometric Distribution Server (BDS) 40. The reduction to practice utilizes Visual Basic software for the Punch Monitor.

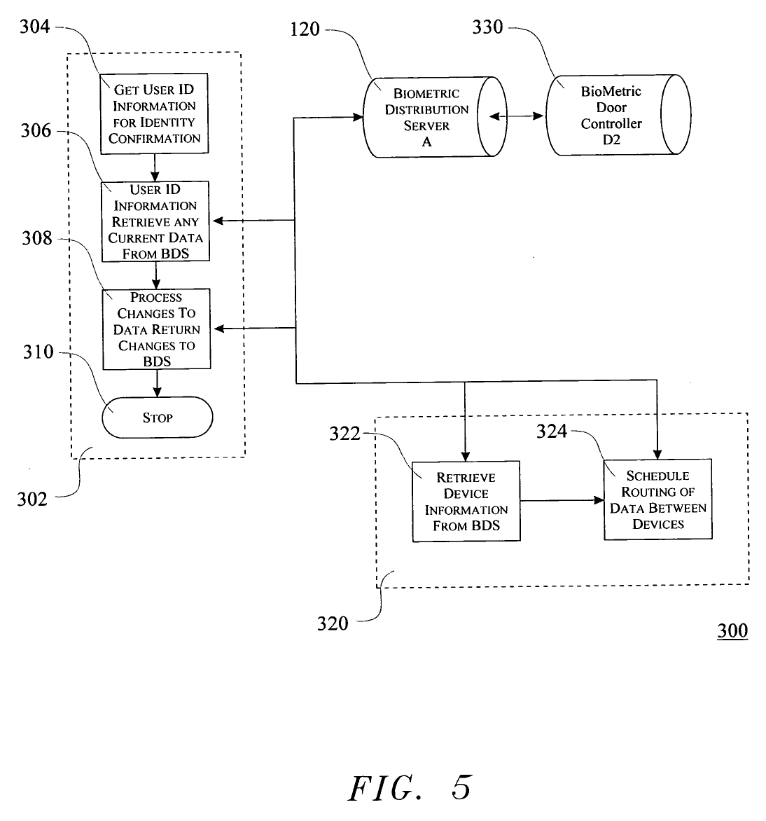

FIG. 5 comprises a flow diagram illustrating the data flow into the Biometric Distribution Server (BDS) 40. The Registration Station 20 comprises two primary functions: Creation of Biometric Data 302 and Administration of Stored Biometric Data 320. Creation of Biometric Data 302 comprising the steps of Getting User ID 304, Retrieving Current User ID 306, Processing any changes to data 308, and stop 310.

Getting User ID 304 provides the administrator the ability to create User ID information for identity confirmation. This would be accomplished by requesting the User place his finger onto the Biometric Sensor 30. The Registration Station 20 then creates and records the fingerprint template. The administrator enters any additional information respective to the User such as User Name, which Bioclock® device 120 the User might be using, and the expected time which the user would be using any respective Bioclock® device 120. Retrieving Current User ID 306 provides the administrator the ability to retrieve current User ID data from the Biometric Distribution Server (BDS) 40. Processing any changes to data 308 provides the administrator the ability to make changes to the User ID file and update the respective data file on the Biometric Distribution Server (BDS) 40. Any of the above steps can be combined to read current data, obtain new data, replace the existing stored data, and the like.

Administration of Stored Biometric Data 320 comprises the steps of Retrieving Device Information 322 and Scheduling Routing 324. Retrieving Device Information 322 comprises the step of retrieving information from the Biometric Distribution Server (BDS) 40. Scheduling Routing 324 comprises the step of scheduling routing of the template information between the various devices.

Additional Administrative features can include:
Optimization of Data Storage
Anti Aliasing of Biometric Data
Distribution of Biometric Data to all or specific devices
Synchronization of Biometric Data with other Biometric Distribution Server (BDS) 40 either connected or remote.
Schedule Automatic Jobs for Maintenance of Biometric Data and Distribution of Data

The information is then interfaced to the Bioclock® device 120 such as a Biometric Door Controller 330.

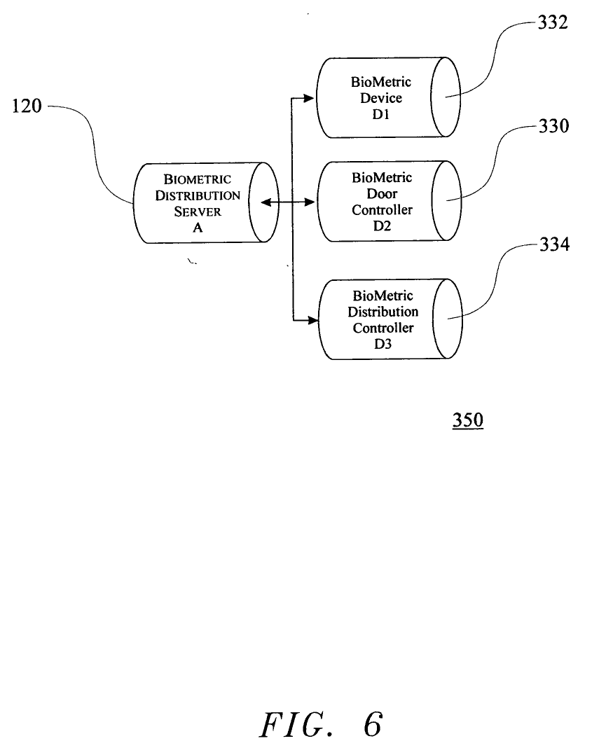

FIG. 6 depicts a flow diagram illustrating a Biometric Distribution Server/Device outward interface 350 which provides an interface between the Biometric Distribution Server (BDS) 40 and a variety of specific Bioclock® devices 120, such as Biometric Door Controller (D2) 330, Biometric device (D1) 332, and Biometric Distribution Controller (D3) 334. It can be recognized that said present invention combines at least one Biometric Distribution Server (BDS) 40 and at least one, preferably a plurality of Bioclock® devices 120. This figure illustrates only a select number of examples. It can be recognized that the present invention is not limited to the actual applications as illustrated.

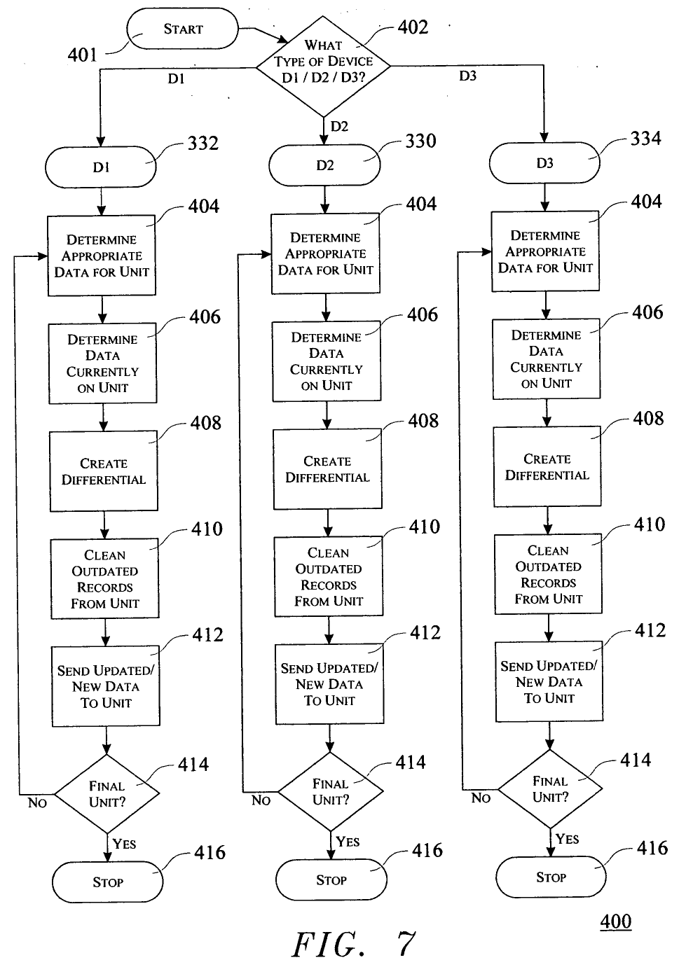

FIG. 7 depicts a flow diagram illustrating a detailed Biometric Distribution Server/Device outward interface 400 which provides an detailed interface between the Biometric Distribution Server (BDS) 40 and a variety of specific Bioclock® devices 120, such as Biometric Door Controller (D2) 330, Biometric device (D1) 332, and Biometric Distribution Controller (D3) 330 as described at a higher level in FIG. 6. In a first detailed outward interface step 401, the process is initialized (start). In a second detailed outward interface step 402, the Biometric Distribution Server (BDS) 40 recognizes which units are required to be communicated to. This comprises which units, timeframes, and what User ID information is to be transmitted to which specific device. The illustration comprises of three examples, Biometric Door Controller (D2) 330, Biometric device (D1) 332, and Biometric Distribution Controller (D3) 334. Upon completion of the decision point (second detailed outward interface step 402), the system determines the appropriate data for the specific unit. This is provided in the third detailed outward interface step 404. In a fourth detailed outward interface step 406, the system determines what data is currently resident on the specific Bioclock® device 120. This can be accomplished by any of several known means, including but not limited to comparing what the Biometric Distribution Server (BDS) 40 believes is current resident on the specific Bioclock® device 120 and comparing that information to the set of information that is desired on the Bioclock® device 120; by reading the information currently stored on the Bioclock® device 120 and comparing the read information to the set of information that is desired on the Bioclock® device 120. In a fifth detailed outward interface step 408, the Biometric Distribution Server (BDS) 40 creates a differential set of information. In a sixth detailed outward interface step 410, the system removes any non-desired information from the Bioclock® device 120. In a seventh detailed outward interface step 412, the Biometric Distribution Server (BDS) 40 communicates updated/new data to the desired Bioclock® device 120. In an eighth detailed outward interface step 414, the system determines if any additional Bioclock® device 120 are to be updated. If this is the last unit requiring updating at this time, the process continues to the last detailed outward interface step 416 which is stopping. The process continues monitoring against any trigger such as time, wherein when the trigger is met, the system restarts at the first detailed outward interface step 401.

The specification above taught three applications for said Biometric template data management system and respective Bioclock® device 120. Additional applications for the Biometric template data management system and respective Bioclock® device 120 include, but are not limited to:
a patient medical provider verification apparatus
a prisoner monitoring apparatus
at least one of vehicle, aerospace, vessel access, a airline ticket counter, and respective intermediate buildings verification apparatus
a hotel room access verification apparatus
a casino patron and employee verification apparatus
a banking customer and employee verification apparatus
an examinee and examiner verification apparatus
a visa holder verification apparatus

It should be recognized that the above apparatus also teach the method of monitoring each respective application.

It should be noted, that the specific method described of utilizing the present invention is only one example and is provided for illustrative purposes only. A wide variety of other applications and uses adaptable and configured for specific conditions are contemplated.

Although the present invention is taught for fingerprint templates, it should be recognized that the present invention can be applied to other Biometric applications such as Iris recognition, and the like. The process can be applied to similar processes wherein the data required at the reading point is large and if managed at a remote location would dramatically reduce the matching speed at the remote point of registration.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

1. A biometric data management system, the system comprising:
a biometric data server having storage memory;
a communication interface for transferring biometric registration data between the biometric data server's storage memory and a remote Biometric reading device;
an administration station connected to the biometric data server;
data management software residing on the administration station to set parameters of biometric registration data transfer from the biometric data server and the remote Biometric reading device; and,
at least one of:
whereby the biometric registration data may be at least one of copied from and transferred from the biometric data server to the remote biometric reading device under the parameters of the management software and
verification data can reside at the remote biometric reading device until at least one of deleted from and transferred back to the biometric data server under the parameters of the data management software.

2. The biometric data management system of claim 1, the biometric data management system further comprising a registration station in connection said biometric data server for administration of said biometric registration data within.

3. The biometric data management system of claim 2, the biometric data management system further comprising a registration biometric reading device in connection with the registration station each at least one of directly and indirectly in connection with said biometric data server.

4. The biometric data management system of claim 3, the biometric data management system further comprising administration software that aids in the registration of end users through at least one of said registration station and said registration biometric reading.

5. The biometric data management system of claim 1, the biometric data management system further comprising administration software for administration of data on said biometric data server, said administration software further comprising a registration data transfer software component to transfer biometric registration data to the said biometric data server.

6. The biometric data management system of claim 1, the biometric data management system further comprising administration software for administration of data on said biometric data server, said administration software further comprising a management software component to remove distribute biometric registration data on at least one remotely connected reader device.

7. The biometric data management system of claim 1, the biometric data management system further comprising a software component for obtaining data from at least one remotely connected biometric reader device.

8. The biometric data management system of claim 7, the biometric data management system wherein said software component for obtaining data from the remote biometric collection devices has a data clearing software component for clearing at least a portion of the data stored on said at least one remotely connected biometric collection device.

9. The biometric data management system of claim 7, the biometric data management system wherein said component for obtaining data further comprises a data transfer component to transfer collected data to a separate software component having a predefined function.

10. The biometric data management system of claim 1, the biometric data management system further comprising a time and attendance verification software module.

11. A method for managing Biometric Data, the method comprising the steps:
storing Biometric Templates on a Biometric data server having storage memory;
communicating Biometric registration data between the Biometric data server's storage memory and a remote Biometric reading device;
administrating data on said Biometric data server using an administration station;
transferring at least one Biometric Template between said Biometric data server and a remote Biometric reading device in conjunction preprogrammed directives;
at least one of:
storing said at least one Biometric Template on said Biometric reading device for use by said Biometric reading device and
deleting said at least one Biometric Template from said Biometric reading device for reduction of storage requirements on said Biometric reading device, and
utilizing said Biometric reading device for providing control verification.

12. The method for managing Biometric Data of claim 11, wherein said Biometric reading device is utilized for providing control verification for a patient medical provider.

13. The method for managing Biometric Data of claim 11, wherein said Biometric reading device is utilized for providing control verification for prisoner monitoring.

14. The method for managing Biometric Data of claim 11, wherein said Biometric reading device is utilized for providing control verification for access to at least one of vehicle, aerospace, vessel access, a airline ticket counter, and respective intermediate buildings.

15. The method for managing Biometric Data of claim 11, wherein said Biometric reading device is utilized for providing control verification for access a hotel room.

16. The method for managing Biometric Data of claim 11, wherein said Biometric reading device is utilized for providing control verification for at least one of a casino patron and a casino employee.

17. The method for managing Biometric Data of claim 11, wherein said Biometric reading device is utilized for providing control verification for at least one of a banking customer and a bank employee.

18. The method for managing Biometric Data of claim 11, wherein said Biometric reading device is utilized for providing control verification for at least one of an examinee and an examiner.

19. The method for managing Biometric Data of claim 11, wherein said Biometric reading device is utilized for providing control verification for a visa holder.

20. A method for managing Biometric Data, the method comprising the steps:
creating Biometric templates using a Biometric reading device;
storing said Biometric Templates on a Biometric data server having storage memory;
communicating Biometric registration data between the Biometric data server's storage memory and a remote Biometric reading device;
administrating data on said Biometric data server using an administration station;
transferring at least one Biometric Template between said Biometric data server and a remote Biometric reading device in conjunction preprogrammed directives;
storing said at least one Biometric Template on said Biometric reading device for use by said Biometric reading device;
deleting said at least one Biometric Template from said Biometric reading device for reduction of storage requirements on said Biometric reading device;
utilizing said Biometric reading device for providing control verification; and
storing at least a portion of data obtained from said Biometric reading device on said Biometric data server.
